(19) United States
(12) Patent Application Publication
(10) Pub. No.: US 2024/0125128 A1
(43) Pub. Date: Apr. 18, 2024

(54) DIGITALLY PRINTED PLATE, MANUFACTURING METHOD, AND APPLICATION

(71) Applicant: Taizhou Gorgeous New Materials Co., Ltd, Jiangsu (CN)

(72) Inventors: Jun Yuan, Jiangsu (CN); Quanshan Cheng, Jiangsu (CN); Juan Chen, Jiangsu (CN); Haiqing Qian, Jiangsu (CN); Rong Jiang, Jiangsu (CN); Yuan Liu, Jiangsu (CN)

(21) Appl. No.: 18/270,673

(22) PCT Filed: Mar. 24, 2021
(86) PCT No.: PCT/CN2021/082739

§ 371 Date: Jun. 30, 2023

(30) Foreign Application Priority Data
Dec. 31, 2020 (CN) 202011642555.8

(51) Int. Cl. E04F 13/08; A47B 96/20; B41C 1/00; B41N 1/00; B41N 6/00; E04F 15/10

(52) U.S. Cl. CPC E04F 13/0866; A47B 96/206; B41C 1/003; B41N 1/00; B41N 6/00; E04F 15/107; B41M 5/0058

(57) ABSTRACT

This invention discloses digitally printed plate, the manufacturing method and applications thereof, is characterized in that the digitally printed plate is of respectively from top to bottom surface lacquer layer, texture layer, second wear layer, first wear layer, pattern layer, bottom lacquer layer, base layer. The digitally printed plated has various patterns, with sufficient materials, printing unrepeatable stereoscopic pattern is possible, so it can satisfy customers' personalized customization requirements, without wasting abundant time or cost, and with process reduced, production efficiency is improved, enabling order manufacturing order insert and sample making at any time.

### TECHNICAL FIELD

This invention belongs to technical field of decorative panel, mainly involves digital printed plate, manufacturing method and application thereof.

### BACKGROUND TECHNOLOGY

Digital printer is capable of printing any texture or any anomaly soft or hard object, such as metal, ceramic, crystal, glass, acrylic, stone, PVC, plastic, toy, flash drive, cloth, wood, silica gel, leather, and artificial board. As with the upsides of no relying on film plate making, the digital printer is capable of imaging in full color at one time, with precise positioning resulting in 0 rejection rate, so that digital printers enable lowering cost, reducing labor cost, raising efficiency. The high-tech product of digital printer is capable of totally replacing traditional processes such as screen printing, pad and transfer printing, and is of environmental type product.

The printed material by digital printer is with image of high-definition colors, and with no touching print material, making print material be kept intact. Printing and dyeing are performed via spraying ink, causing no transformation due to heat and pressure, and with output printing directly from computer, so no preparation for printing in previous is required.

As the current pattern of decorative panel requires printing, pattern rolls which require long time and high cost, should be made in advance. The surface embosses and wear resistance, which are made through adding wear resistant material and being hot pressed with emboss board, require long time and high cost. The pattern of board highly repeats, unable to satisfy the requirements of personalized customization.

### CONTENT OF INVENTION

The aim of this invention is to overcome the disadvantage of current technology, by providing a kind of making highly efficient digital printed plate with highly personalized customization, manufacturing method and application thereof.

The digital printed plate of this invention is respectively from top to bottom, surface lacquer layer, texture layer, second wear layer, first wear layer, adhesive layer, pattern layer, bottom lacquer layer, and base layer.

Furthermore, the stated bottom lacquer layer is made through roll coating or spraying UV bottom lacquer on the base material and light curing, the color of bottom lacquer depends on the requirements of printed pattern and is normally white or any other color according to the printed pattern. In addition, the chemical polarity of base material is adjustable to improve adhesion for printing.

Furthermore, the stated pattern layer is made through printing pattern with multiple color UV oil ink printer on UV bottom lacquer layer and light curing. Printing various patterns such as wood, stone, or personized customized texture is possible.

Furthermore, the stated first wear layer is made through roll coating transparent UV wear resistant adhesive lacquer on texture layer and semi curing with the use of UV light, playing the role of insolation to protect texture layer, and improve the stickiness between texture layer and wear layer.

Furthermore, the stated second wear layer is made through multiple times roll coating transparent UV wear resistant lacquer on the first wear layer, keeping moist and uncured, and the times and weight of roll coating depends on the wear resistant level according to actual requirements.

Furthermore, the stated texture layer is made through printing transparent stereoscopic texture layer with texture oil ink on the second wear layer with digital printer, removing abundant cured texture oil ink with brush machine, revealing texture, and forming the texture layer which is stated in this invention. The thickness of texture layer depends on the required depth of texture, and the emboss in register texture is possible to be made according to pattern.

Furthermore, the stated surface lacquer layer is made through roll coating transparent UV surface lacquer on texture layer and light curing, the function of this layer is to protect texture layer and adjust the gloss of surface, realizing glossy finish and matte finish.

Furthermore, the stated base material could be board of any kind of material, such as metal, ceramic, crystal, glass, stone, plastic, wood, rubber, artificial board, aluminum oxide board, and concrete board.

The manufacturing method of stated digital printed plate is, roll coating UV bottom lacquer on base board, and forming UV bottom lacquer layer after being light cured; printing with multiple color oil ink printer on UV bottom lacquer layer and forming pattern layer after being light cured; roll coating transparent UV wear resistant adhesive bottom lacquer on pattern layer and forming the first wear layer after being semi cured with the use of UV light; digitally printing transparent stereoscopic texture on the second wear layer and light curing, removing abundant cured texture oil ink with brush machine, revealing textures to form texture layer; eventually roll coating transparent UV surface lacquer on texture layer and forming surface lacquer layer after being light cured, so the digital printed plate of this invention is made.

The stated digital printed plate is capable of being cut and made into decorative panels such as flooring, wall board, and furniture board; and of being profiled and made into decorative panels with click structure such as flooring, wall board, and furniture board.

To compare with existing technology, the beneficial effect of this invention is that the digital printed plate has variety of patterns, with sufficient materials, the stereoscopic texture is able to be printed unrepeatably, to satisfy personized customized requirement from customers, without wasting vast of time and cost, reducing manufacturing process, raising manufacturing efficiency, making insert manufacturing order and sample possible. Also, the board is formed in one time, with easy method, wide application range, after being cut or profiled it can be applied to be decorative panels in different application environment.

### DESCRIPTIONS FOR THE FIGURES

To make the content of this invention easier to be clearly understood, here in the following are actual detailed implementations in combination with attached figures to describe this invention in detail, thereof:

FIG. 1 is the instruction figure of the structure of the digital printed plate in this invention

The attached tags are: 1—surface lacquer layer, 2—textuer layer, 3—second wear layer, 4—first wear layer, 5—pattern layer, 6—bottom lacquer layer, 7—base layer.

### DETAILED IMPLEMENTATIONS

Here in the following further describes this invention with combination of attached figures, but the protection range of this invention shall not be limited within the implementation in the following. Any equivalent change made by technic personnel in this field which is inspired by this invention shall be included in the protection range of this invention.

### Implementation 1

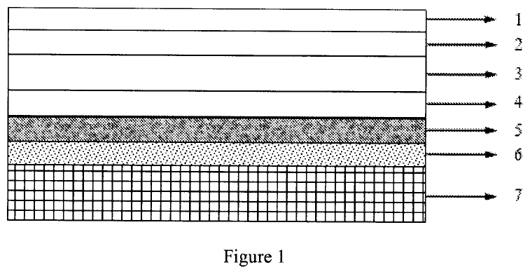

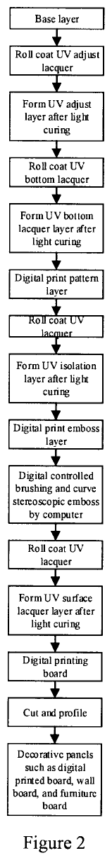

A kind of digital printed plate as shown in FIG. 1 is respectively from top to bottom surface lacquer layer 1, texture layer 2, second wear layer 3, first wear layer 4, pattern 5, bottom lacquer layer 6, base layer 7.

Furthermore, the stated bottom lacquer layer 6 is made through roll coating or spraying UV bottom lacquer on base layer 7 and forming after being light cured, the color of bottom lacquer is according to requirements of printed pattern, which is normally white or any other color according to the requirements of printed pattern. The chemical polarity of the base material of this layer is adjustable to improve the adhesion to make it easier to print.

Furthermore, the stated pattern layer 5 is made through printing pattern with multiple color UV oil ink printer on UV bottom lacquer layer 6 and forming after being light cured, the printed pattern could be patterns such as wood, stone, or any personized customized patterns.

Furthermore, the stated adhesion layer is made through roll coating transparent UV adhesive lacquer on pattern layer, the function of this layer is being as isolation to protect pattern layer, improving the adhesion between pattern layer and wear layer.

Furthermore, the stated second wear layer 4 is made through roll coating transparent UV wear resistant adhesive bottom lacquer on pattern layer 5 and semi curing with the use of UV light and is acting as isolation to protect pattern layer 5, improving the adhesion between pattern layer 5 and wear layer.

Furthermore, the stated second wear layer 3 is made through multiple times of roll coating transparent UV wear resistant lacquer on the first wear layer 4, being kept moist and uncured. The time and weight of roll coated wear resistant lacquer depend on wear resistant level according to requirements.

Furthermore, the stated texture layer 2 is made through printing texture oil ink with digital printer on the second wear layer 3 to make transparent stereoscopic texture layer, removing abundant cured texture oil ink with brush machine, revealing texture and forming the stated texture layer of this invention. The thickness of texture layer is determined by the depth of required texture, and the emboss in register texture could be made according to pattern.

Furthermore, the stated surface lacquer 1 is made through roll coating transparent UV surface lacquer on texture layer and light curing, this layer is to protect texture layer and adjust surface gloss, realizing glossy finish and matte finish.

Furthermore, the stated base layer 7 could be board which is made of materials such as metal, ceramic, crystal, glass, wood, plastic, wood, rubber, artificial board, aluminum oxide board, and concrete board.

### Implementation 2

The manufacturing method of the stated digital printed plate stated in implementation 1 is roll coating UV bottom lacquer on base layer 7 and forming UV bottom lacquer layer 6 after light curing; printing with multiple color oil ink printer on UV bottom lacquer layer 6 and forming pattern layer 5 after light curing; roll coating transparent UV wear resistant adhesive lacquer on pattern layer 5 and forming the first wear layer 4 after semi curing with the use of UV light; roll coating UV wear resistant lacquer multiple times on the first wear layer 4, keeping moist and uncured, forming second wear layer 3; printing stereoscopic texture layer on digital printer on the second wear layer 3 and light curing, removing abundant cured texture with brush machine, revealing texture and forming texture layer 2; roll coating transparent UV surface lacquer on texture and forming surface lacquer layer 1 after light curing, so the digital printed plate is made.

The stated digital printed plate is capable of being cut and made into decorative panels such as flooring, wall board, and furniture board; and of being profiled and made into decorative panels with click structure such as flooring, wall board, and furniture board.

1. Digital print board is characterized in that the stated digital print board is respectively from top to bottom surface lacquer layer, texture layer, second wear layer, first wear layer, pattern layer, bottom lacquer layer, base layer, wherein
The stated bottom lacquer layer is formed of light curing the UV lacquer after being roll coated or sprayed on the base layer;
The stated pattern layer is formed of light curing the printed pattern which is made by colorful UV oil ink printer on the UV bottom lacquer layer;
The stated first wear layer is made through semi-curing the transparent UV wear resistant adhesive bottom paint which is roll coated on pattern layer by UV light;
The stated second wear layer is made through multiple times of roll coating the transparent UV wear resistant paint on the first wear layer;
The stated texture layer is made through printing texture oil ink on the second wear layer by digital printer, forming transparent stereoscopic texture layer, then remove redundant cured texture oil ink with brush machine, eventually revealing the textures forming the stated texture layer;
The stated surface lacquer layer is made through light curing the UV paint which is roll coated on texture layer; and
The stated base layer is the board made of basic material.

2. The digital printed plate according to claim 1 is characterized in that the stated second wear layer, which is made through multiple times roll coating transparent UV wear resistant paint one the first wear layer, shall be kept moist and uncured. The roll coating times, and weight of wear resistant paint shall be determined by wear resistant level.

3. The digital printed plate according to claim 1 is characterized in that the stated surface lacquer layer would protect texture layer, adjust the glossiness of surface, realizing gloss finish or matte finish.

4. The digital printed plate according to claim 1 is characterized in that the stated basic material is one kind of metal, ceramic, crystal, glass, stone, plastic, wood, rubber, artificial board, magnesium oxide board, and concrete board.

5. The manufacturing method of the stated digital printed plate according to claim 1 is, foaming UV bottom lacquer layer through roll coating UV bottom lacquer on the base board and curing; forming pattern layer through printing with colorful oil ink digital printer on UV bottom lacquer layer and curing; forming the first wear layer through roll coating UV wear resistant adhesive bottom paint on pattern layer and semi light curing by UV light; forming the second wear layer through roll coating UV wear resistant paint multiple times on the first wear layer and keeping it moist and uncured; printing transparent stereoscopic texture layer with digital printer on the second wear layer and light curing, removing redundant cured texture oil ink with brush machine, revealing texture and forming texture layer; eventually roll coating UV surface lacquer on texture layer and forming surface lacquer layer after being light cured, finally into digital printed plate.

6. The application in decorative panel of the stated digital printed plate according to the claim 1.

7. The application of digital printed plate stated in claim 6 in decorative panel is characterized in that the stated digital printed plate is capable of being cut and made into decorative panels such as flooring, wall board, and furniture board; and of being profiled and made into decorative panels with click structure such as flooring, wall board, and furniture board.

8. The manufacturing method of the stated digital printed plate according to claim 2 is, foaming UV bottom lacquer layer through roll coating UV bottom lacquer on the base board and curing; forming pattern layer through printing with colorful oil ink digital printer on UV bottom lacquer layer and curing; forming the first wear layer through roll coating UV wear resistant adhesive bottom paint on pattern layer and semi light curing by UV light; forming the second wear layer through roll coating UV wear resistant paint multiple times on the first wear layer and keeping it moist and uncured; printing transparent stereoscopic texture layer with digital printer on the second wear layer and light curing, removing redundant cured texture oil ink with brush machine, revealing texture and forming texture layer; eventually roll coating UV surface lacquer on texture layer and forming surface lacquer layer after being light cured, finally into digital printed plate.

9. The manufacturing method of the stated digital printed plate according to claim 3 is, foaming UV bottom lacquer layer through roll coating UV bottom lacquer on the base board and curing; forming pattern layer through printing with colorful oil ink digital printer on UV bottom lacquer layer and curing; forming the first wear layer through roll coating UV wear resistant adhesive bottom paint on pattern layer and semi light curing by UV light; forming the second wear layer through roll coating UV wear resistant paint multiple times on the first wear layer and keeping it moist and uncured; printing transparent stereoscopic texture layer with digital printer on the second wear layer and light curing, removing redundant cured texture oil ink with brush machine, revealing texture and forming texture layer; eventually roll coating UV surface lacquer on texture layer and forming surface lacquer layer after being light cured, finally into digital printed plate.

10. The manufacturing method of the stated digital printed plate according to claim 4 is, foaming UV bottom lacquer layer through roll coating UV bottom lacquer on the base board and curing; forming pattern layer through printing with colorful oil ink digital printer on UV bottom lacquer layer and curing; forming the first wear layer through roll coating UV wear resistant adhesive bottom paint on pattern layer and semi light curing by UV light; forming the second wear layer through roll coating UV wear resistant paint multiple times on the first wear layer and keeping it moist and uncured; printing transparent stereoscopic texture layer with digital printer on the second wear layer and light curing, removing redundant cured texture oil ink with brush machine, revealing texture and forming texture layer; eventually roll coating UV surface lacquer on texture layer and forming surface lacquer layer after being light cured, finally into digital printed plate.

11. The application in decorative panel of the stated digital printed plate according to the claim 2.

12. The application in decorative panel of the stated digital printed plate according to the claim 3.

13. The application in decorative panel of the stated digital printed plate according to the claim 4.

14. The application in decorative panel of the stated digital printed plate according to the claim 5.
